(19) United States
(12) Patent Application Publication
(10) Pub. No.: US 2010/0011062 A1
(43) Pub. Date: Jan. 14, 2010

(54) AUTOMATED BIOREMEDIATION SYSTEM

(75) Inventors: M. Sam Araki, Saratoga, CA (US); Mobeen Bajwa, Fremont, CA (US); Safwan Shah, San Jose, CA (US); Ashim Banerjee, Westminster, CO (US); Kenneth L. Stutzman, Windsor, CO (US); Donald Araki, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ST-Infonox, Inc., San Jose, CA (US)

(21) Appl. No.: 12/172,974

(22) Filed: Jul. 14, 2008

(51) Int. Cl. G06F 15/16

(52) U.S. Cl. 709/205

(57) ABSTRACT

Embodiments of a bioremediation system and bioremediation methods provide for automatically measuring the progress of a bioremediation effort and automatically adjusting the bioremediation. In embodiments, one or more bioremediation stations are deployed in the geographic area associated with the bioremediation. The bioremediation stations provide measurement of important environment characteristics that help determine the progress of the bioremediation. Each set of data from each bioremediation station can be integrated into a single comprehensive assessment of the bioremediation across a portion or all of the geographical area. If an adjustment needs to be made to the bioremediation, a control message can be sent to the bioremediation station that can then automatically make the adjustment.

### FIELD OF INVENTION

The embodiments presented herein generally relate to the cleanup of environmentally hazardous materials and, more particularly, to bioremediation methods and systems.

### BACKGROUND

Oil spills or chemical spills or other spills occur on occasion during the transport or use of the oil, chemicals, or other materials. Some large oil spills have received significant media attention, such as the oil spill in Prudhoe Bay, Ak. after the Exxon Valdez ran aground while transporting oil from the North Slope of Alaska or the large oil spill in the Persian Gulf during the Iraqi invasion of Kuwait. These large oil spills can cause significant damage to the environment.

Remediation efforts generally include attempts to contain the spill. Special equipment may be deployed in the hours or days following a spill to collect the spilt chemicals or oil. Unfortunately, these efforts generally do not completely clean the spill. Often, the oil or chemicals seep into the ground, sink to the bottom of waterways, or migrate into other areas. Thus, cleaning-up the spills becomes a more protracted and difficult endeavor.

In an effort to further clean-up the oil or chemical spills, bioremediation is often employed. Bioremediation is a process of either promoting or introducing organisms, plants or other flora or fauna to digest or use the oil or chemicals left in the environment. Bioremediation is a lengthy process that may take years to complete the clean-up of a spill. The process generally requires oversight and attention to ensure good conditions for the organisms, plants or other agents used in the clean-up.

Unfortunately, managing the bioremediation process is difficult. Often, the spill covers a large geographic area that is difficult to monitor. A scientist or other worker may make measurements of chemicals, oxygen or other characteristic of the local environment to obtain feedback on the bioremediation progress. Unfortunately, these measurements are only local and determining a comprehensive understanding of the bioremediation process over the entire geographic area is difficult. Further, if adjustments to the bioremediation are needed, a worker or scientist generally must make those adjustments manually.

It is in view of these and other considerations not mentioned herein that the embodiments of the present disclosure were envisioned.

### BRIEF SUMMARY

The embodiments described herein provide for systems and methods for automatically measuring the progress of a bioremediation effort and automatically adjusting the bioremediation. In embodiments, one or more bioremediation stations are deployed in the geographic area associated with the bioremediation. The bioremediation stations provide measurement of important environment characteristics that help determine the progress of the bioremediation. Each set of data from each bioremediation station can be integrated into a single comprehensive assessment of the bioremediation across a portion or all of the geographical area. If an adjustment needs to be made to the bioremediation, a control message can be sent to one or more of the bioremediation stations that can then automatically make the adjustment.

This summary is provided only to present an example of one or more embodiments presented in this disclosure. The invention is as defined by the claims. This summary is not meant to limit the scope or meaning of the disclosure or the claims.

### BRIEF DESCRIPTION OF THE DRAWINGS

The embodiments of the present disclosure are described in conjunction with the appended figures:

FIG. 1 is a block diagram of an embodiment of a bioremediation system providing automatic control for bioremediation;

FIG. 2 is a hierarchical diagram of an embodiment of an arrangement of bioremediation stations in a bioremediation system;

FIG. 3 is a block diagram of an embodiment of a bioremediation station or base station in a bioremediation system;

FIG. 4 is a block diagram of an embodiment of a control station in a bioremediation system;

FIG. 5 is a flow diagram of an embodiment of a method for automatic analysis and control of a bioremediation; and

FIG. 6 is a block diagram of an embodiment of a computer system operable in a bioremediation system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides exemplary embodiment(s) only and is not intended to limit the scope, applicability or configuration of the possible embodiments. Rather, the ensuing description of the exemplary embodiment(s) will provide those skilled in the art with an enabling description for implementing an exemplary embodiment. It is to be understood that various changes may be made in the function and arrangement of elements without departing from the spirit and scope of the possible embodiments as set forth in the appended claims.

Embodiments of the present disclosure provide unique and novel systems and methods for measuring the effectiveness of and controlling a bioremediation. Embodiments include one or more bioremediation stations that may be disbursed in the bioremediation area. The bioremediation stations, in embodiments, measure one or more parameters associated with the bioremediation, such as the presence of one or more chemicals. The bioremediation stations may form a peer-to-peer network. In embodiments, the network may also include one or more base stations that can automatically adjust the bioremediation process, such as by introducing chemicals into the environment to promote the bioremediation process. The bioremediation and base stations can communicate with a central system that provides for analysis of the effectiveness of the bioremediation using measurements from the bioremediation stations. The central system may also adjust the bioremediation by commanding the base stations to introduce agents into the bioremediation environment.

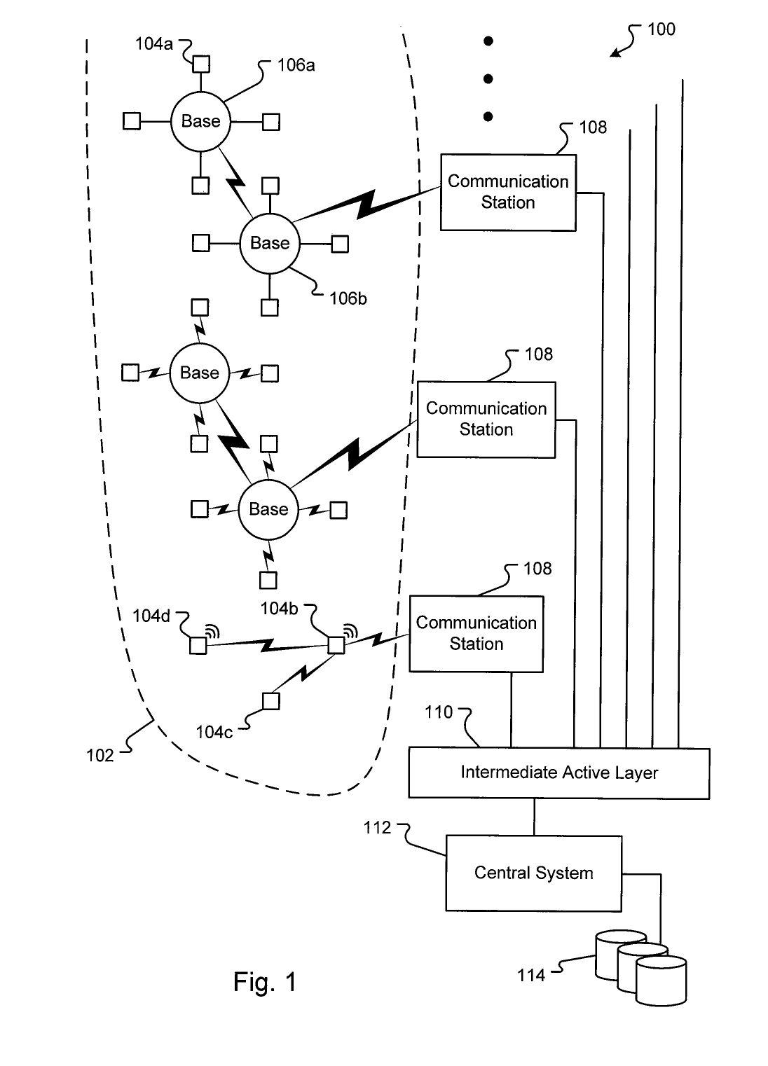

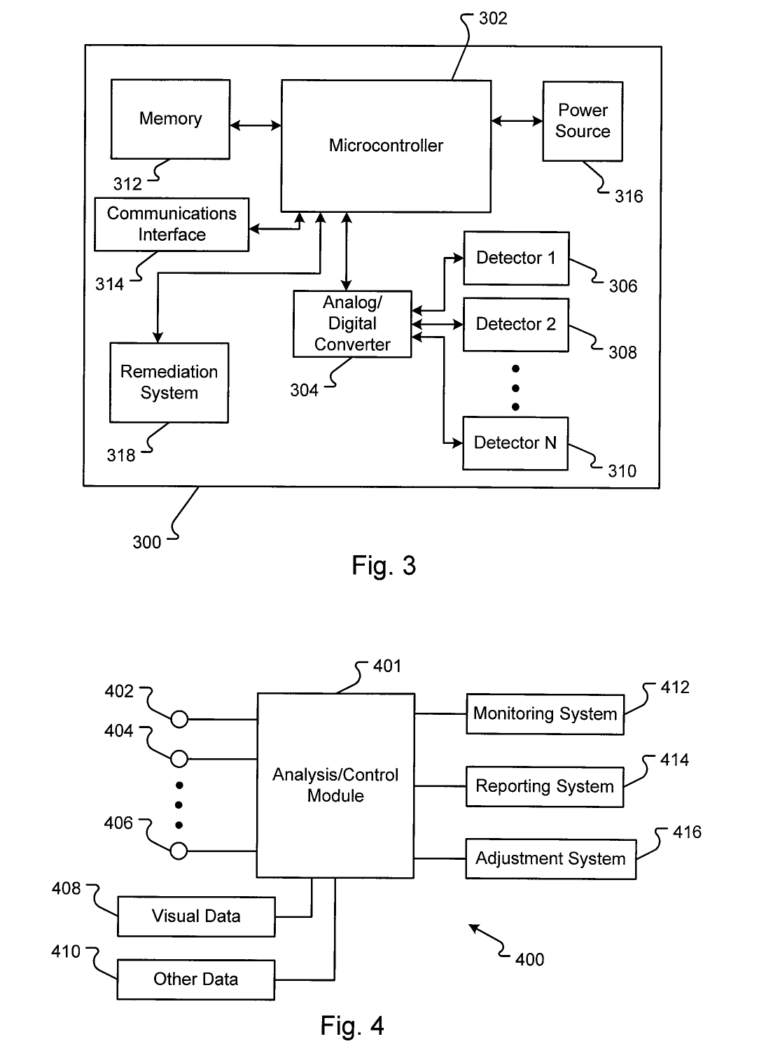

An embodiment of a bioremediation system 100 is shown in FIG. 1. The bioremediation system 100, in embodiments, employs one or more bioremediation stations 104. The distribution of bioremediation stations/sensors 104 generally occupies geographic area 102, which is intended to illustrate that the bioremediation stations 104 have a physical distribution that corresponds to the geographic distribution of the oil spill or the area associated with the bioremediation. The bioremediation area 102 may occupy one or more physical environments. For example, one or more bioremediation stations 104 may be deployed on dry land, one or more bioremediation stations 104 may be deployed in a marine environment, or one or more bioremediation stations 104 may be deployed in a marsh or other environment. In embodiments, one or more test wells may be drilled to determine the condition of the subterranean environment and one or more bioremediation stations 104 may be placed in the test wells. At least one embodiment of the bioremediation stations 104 is described in conjunction with FIG. 3.

The bioremediation stations 104 may be any hardware, software, or hardware and software for measuring characteristics of a bioremediation and/or adjusting the bioremediation function. The bioremediation stations 104 may be stand-alone devices, for example, bioremediation station 104b is a stand-alone device, or be connected to a base station 106, for example bioremediation station 104a is connected to base station 106a. The base station 106 may include the same or different features of the bioremediation stations 104. For example, the bioremediation stations 104 and the base station 106 may have one or more sensors for measuring a parameter associated with the bioremediation. However, in alternative embodiments, only the base station 106 may have one or more systems for introducing chemicals, water, enzymes, plant seeds, oxygen, or other agents into the bioremediation area 102 to correct or enhance the bioremediation effort. In embodiments, the bioremediation stations 104 communicate directly with the base station 106, by a wired connection, wireless connection, or other communication connection. The base station 106 may then control the introduction of agents or other materials for the entire area covered by the base station 106 and the connected bioremediation stations 104.

The base station 106 may be any hardware, software, or hardware and software for measuring characteristics of a bioremediation and/or adjusting the bioremediation. A first base station 106a, in embodiments, may network with a second base station 106b. The second base station may then communicate with a communication station 108. All measurements from bioremediation station 104a can be communicated to the communication station 108 through the base station 106a and the base station 106b. Thus, bioremediation station 104a need not be able to communicate directly with communication station 108 to send data to the communication station 108.

In embodiments, the base stations 106 and/or bioremediation stations 104 create a peer-to-peer network created with peer-to-peer communications that form dynamic network paths. The dynamic peer-to-peer network is not constrained by the physical arrangement of the bioremediation stations 104 or base station 106. That is, several bioremediation stations 104 or base stations 106 may be isolated physically but, at the same time, their actual physical separation for wireless communication may be sufficiently short that peer-to-peer communications may be established between the bioremediation stations 104 and/or base stations 106. For example, base station 106a networks with base station 106b. Likewise, bioremediation stations 104d and 104c network with bioremediation station 104b.

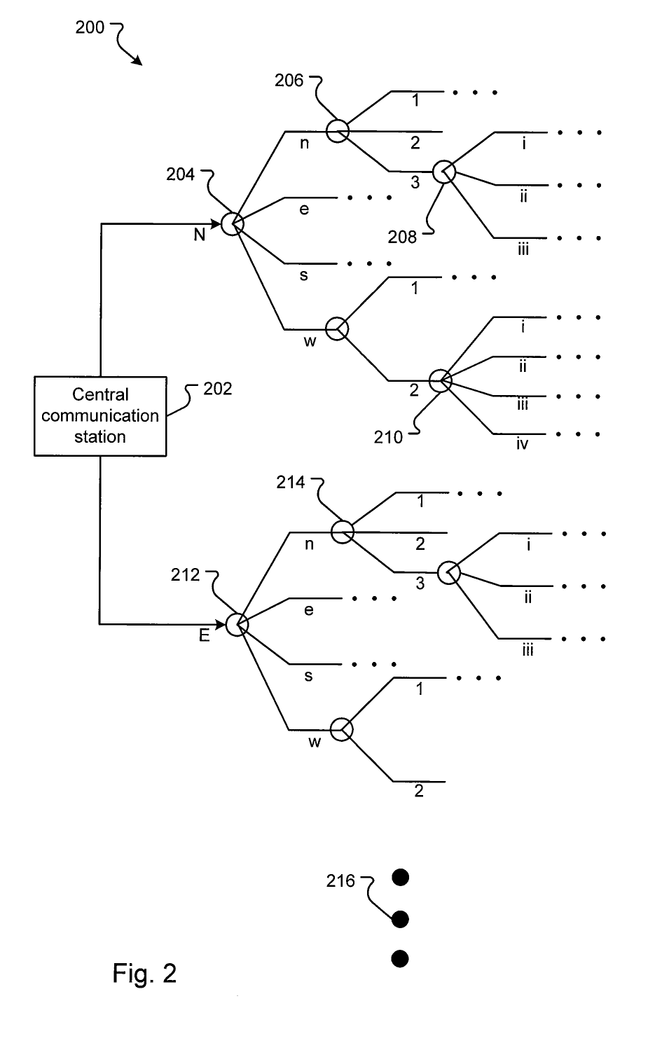

Each bioremediation station 104 generally maintains or obtains information identifying the bioremediation station's 104 location, which the bioremediation station 104 transmits with the data describing the bioremediation. The location information may be in the form of an actual physical coordinate (determined through a physical survey or other method), a GPS reading, or may sometimes be provided in terms of the logical hierarchical branching structure of the bioremediation system network, as will be described in conjunction with FIG. 2. That is, a particular bioremediation station 104 may broadcast that the bioremediation station 104 is located in a particular geographical area by using an identification of the hierarchy illustrated in FIG. 2, i.e. by broadcasting that the particular bioremediation station is in the section of the geographic area between two identified nodes or by specifying the position in the hierarchy with a label.

Communications stations 108, in embodiments, are any hardware or software required to communicate with the base stations 106 and/or bioremediation stations 104. Communication stations 108 are distributed so that dynamic network paths, created by the peer-to-peer communications of the bioremediation stations 104 and/or base stations 106, may be used to access the data being provided by each of the bioremediation stations 104 and/or base stations 106 distributed within the bioremediation area 102. The total amount of data collected depends on the overall size of the bioremediation area 102 and on the number of bioremediation stations 104 and/or base stations 106 distributed within the bioremediation area 102. The communication station 108 is operable to communicate with one or more of the bioremediation stations 104 and/or base stations 106 to receive bioremediation data from one or more of the bioremediation stations 104 and/or base stations 106 in the network. In further embodiments, the communication station 108 communicates commands to the one or more bioremediation stations 104 and/or base stations 106.

An intermediate active layer 110 is any hardware, software, or hardware and software for receiving and aggregating the data from the several bioremediation stations 104 and/or base stations 106. One or more embodiments of the active layer 110 may be as described in U.S. patent application Ser. No. 10/839,980, filed May 5, 2004, entitled “Methods And Systems For Monitoring Environments,” or U.S. Pat. No. 6,947,902, issued Sep. 20, 2005, entitled “Active Transaction Generation, Processing, and Routing System,” both commonly assigned with the present application, which both applications are incorporated herein by reference for all that the applications teach. The intermediate active layer 110 may be provided to allow both coordination of the information from the different bioremediation stations 104 and/or base stations 106 to be performed and to allow a central system 112 to be used in performing monitoring and control functions. The central system 112 is any hardware, software, or hardware and software for analyzing the data from the several bioremediation stations 104 and/or base stations 106 and which can control the bioremediation by sending commands to the several bioremediation stations 104 and/or base stations 106. The relevant data, in embodiments, is stored for access by the central system 112 on one or more databases 114.

In embodiments, The intermediate active layer 110 comprises a suite of server and client resident software that enables data collection and bioremediation control. The central system 112 acts to perform analyses, such as those described above in determining the effectiveness of the bioremediation, and to control changes to the bioremediation, such as those described above in adjusting agents introduced in the environment.

A reporting system 116 can include hardware, software, or hardware and software for reporting the health of the one or more bioremediation stations 104 and/or base stations 106. The bioremediation stations 104 and/or base stations 106 can send health status to communication stations 108 then on to central system 112. If an anomaly or change has occurred, movement in the bioremediation stations 104, faulty battery, depletion of bioremediation agent, etc., a report or signal may be generated by the reporting system 116. The report can alert a person to ameliorate the problem.

There are a number of embodiments in which the bioremediation area 102 is one of several environments that may be monitored simultaneously. For example, a second bioremediation system might be monitored in which a structure similar to that described in connection with FIG. 1 is used for adjusting the bioremediation, such as for the bioremediation in a river or other watershed. The monitoring and controlling of each of the bioremediation systems may be performed similarly to that described above, using a network of distributed sensors having peer-to-peer communications capabilities. The data from separate environments may, moreover, itself be coupled to identify multi-environment events, such as by using techniques described in greater detail in copending, commonly assigned U.S. patent application Ser. No. 10/839,980, entitled “METHODS AND SYSTEMS FOR MONITORING ENVIRONMENTS,” filed May 5, 2004 by M. Sam Araki et al., the entire disclosure of which is incorporated herein by reference for all purposes. That application additionally includes further description of the application of fuzzy logic in processing data for the identification of potential changes, and such application of fuzzy logic may be used in the types of analysis described above for specific analysis of bioremediation environments.

The structure of geography of the bioremediation area 102 (FIG. 1) may determine the positions of the bioremediation stations 104 (FIG. 1) and/or base stations 106 (FIG. 1) as shown in FIG. 2. A central communication station 202, similar or the same as communication station 108 (FIG. 1), may be positioned at the center of a portion of the bioremediation area 102 (FIG. 1). The bioremediation stations 104 (FIG. 1) and/or base stations 106 (FIG. 1) may be positioned as spokes radiating from the central communication station 202. As such, a first branch extending North from the central communication station 202 may be designated with an “N.” A second branch extending East from the central communication station 202 may be designated with an “E.” Smaller sub-branches may radiate from nodes or base stations 106 (FIG. 1) located along the branches. One or more other branches are represented by ellipses 216.

With the hierarchical arrangement 200 shown in FIG. 2, the location of a bioremediation station 104 (FIG. 1) and/or base station 106 (FIG. 1) is in a predetermined geographical area and may be specified in accordance with a hierarchical branching arrangement, with examples of identifications provided in the drawing. For instance, a bioremediation station 104 (FIG. 1) located in the geographical area between node 204 and node 208 may have its location specified uniquely by specification of those two nodes, or may be specified as being located in conduit Nn3 (where N or n may specify North and node 206 is between node 204 and node 208). Similarly, a bioremediation station 104 (FIG. 1) located in the geographical area between node 212 and node 214 may have the location specified uniquely in terms of those two nodes or by identifying the bioremediation station 104 (FIG. 1) as being located in conduit En (where E may specify East and n specifies North). As a further example, node 210 would have a location of Nw2.

Under normal circumstances, the bioremediation stations 104 (FIG. 1) will be fixed in positions in the bioremediation area 102 (FIG. 1) to permit the collection of data with known positions. Part of the analytical information used in evaluating the effectiveness of the bioremediation thus includes a position for each of the sensors, thereby permitting adjustments to portions of the bioremediation area 102 (FIG. 1) to be localized. For example, one enzyme or chemical may work better with the local vegetation in a first microenvironment within the bioremediation area 102 (FIG. 1) compared to another enzyme or chemical used in a second microenvironment. These differences in how to adjust the bioremediation becomes further important if the environments are different, for example, a marine environment is different from a desert environment. The separation of the bioremediation area 102 (FIG. 1) into areas and identifying the location of the bioremediation stations 104 (FIG. 1) and/or base stations 106 (FIG. 1) allows for control of the bioremediation at a more granular and localized level.

An embodiment of a system 300 of either a bioremediation station 104 (FIG. 1) or base station 106 (FIG. 1) is shown in FIG. 3. In embodiments, each bioremediation station 104 (FIG. 1) and/or base station 106 (FIG. 1) is self-contained, including a microcontroller 302 that coordinates functionality of the bioremediation station 104 (FIG. 1) and/or base station 106 (FIG. 1) and a power source 316 that provides operational power. In some alternative embodiments, the bioremediation station 104 (FIG. 1) and/or base station 106 (FIG. 1) may not include a separate power source but may instead have a device for extraction of power from the external environment. For instance, a solar array might be used in some embodiments to power the bioremediation station 104 (FIG. 1) and/or base station 106 (FIG. 1). In other embodiments, the power source 316 may be a source of power supplied from another component of the bioremediation system 100 (FIG. 1). For example, a base station 106 (FIG. 1) supplies power to one or more bioremediation stations 104 (FIG. 1) connected to the base station 106 (FIG. 1). A memory 312 may store information used by the microcontroller 302, such as programming instructions used by the microcontroller 302 or such as data used by the microcontroller 302 in implementing embodiments of the disclosure.

The microcontroller 302 may be in communication with a communications interface 314, which permits electromagnetic signals to be transmitted and received by the bioremediation station 104 (FIG. 1) and/or base station 106 (FIG. 1), thereby enabling communication with other bioremediation stations 104 (FIG. 1) and/or base stations 106 (FIG. 1) and establishment of an ad hoc network. The communications interface 314 may be a radio transceiver, a satellite transceiver, an optical transceiver, or other hardware and associated software for receiving and sending signals. In embodiments, the communications interface 314 is an uplink to a low bandwidth cellular satellite channel. In one embodiment, the communications interface 314 is a radio with a range of 10-1000 feet, although embodiments are not restricted to any particular range, relying only on there being sufficient range that a network may be established. The combination of the communications interface 314 and microcontroller 302 can act as a transceiver that enables peer-to-peer communications to be effected among the bioremediation stations 104 (FIG. 1) and/or base stations 106 (FIG. 1). The communications interface 314 allows each bioremediation station 104 (FIG. 1) and/or base station 106 (FIG. 1) to find other bioremediation stations 104 (FIG. 1) and/or base stations 106 (FIG. 1) within radio range and create a dynamic network path to a communications station 108 (FIG. 1). In embodiments, data from each bioremediation station 104 (FIG. 1) and/or base station 106 (FIG. 1) reaches the communications station 108 (FIG. 1) using this dynamic network path.

The microcontroller 302 is also generally interfaced with a number of detectors 306, 308, and/or 310, perhaps through an analog/digital converter 304 as appropriate. The detectors 306, 308, and/or 310 can provide measurement of several different characteristics or parameters associated with the bioremediation. The analog/digital converters are well known in the art and will not be described herein. Embodiments may include a light detector, which may be a photodiode, a phototransistor, or other light-sensitive electronic component. The light detector is used in combination with a light source whose operation is also provided under the control of the microcontroller 302. In some embodiments, the detectors 306, 308, and/or 310 may also include a chemical detector 310 adapted to identify the presence of certain substances in the environment. For instance, such a chemical detector 310 might comprise a material having selective binding sites that will react in the presence of the substance. Furthermore, the detectors 306, 308, and/or 310 may comprise other detectors configured to detect temperature, pH levels, oxygen, oxygen reduction potential redox, carbon dioxide concentration, flow rate monitor, conductivity, or the like. In embodiments, the detectors may also include a camera.

The bioremediation stations 104 (FIG. 1) and/or base stations 106 (FIG. 1) may also include a remediation system 318. The remediation system 318, in embodiments, is controlled by the microcontroller 302 and provides for adjusting the bioremediation. For example, the remediation system 318 may introduce chemicals or agents into the environment to adjust or enable the bioremediation. In embodiments, the remediation system 318 is connected to one or more physical systems for dispersing such agents, such as a chemical sprayer or spreader. The microcontroller 302 is operable to send commands to the remediation system 318 to make the adjustments. The remediation system may include one of, but is not limited to, water injectors, oxygen injectors, chemical applicator, fertilizer applicator, fertilizer diluter, etc. Health and status monitors may also be controlled and read by the microcontroller 302. Health and status monitors can determine battery charge, amount of fertilizer remaining, severe weather, GPS alarms, and other conditions of the base stations 106 (FIG. 1) or bioremediation stations 104 (FIG. 1).

An embodiment of a central system 400, similar or the same as central system 112 (FIG. 1) is shown in FIG. 4. The central system 400 may include hardware, software, or hardware and software operable to complete the operations described herein. The central system 400, in embodiments, includes an analysis/control module 401, a monitoring system 412, a reporting system 414, and/or an adjustment system 416. The central system 400 communicates with one or more sensors 402, 404, and 406, which may be similar or the same as the bioremediation stations 104 (FIG. 1) and/or base stations 106 (FIG. 1). An analysis/control module 401 is equipped to receive data from a plurality of sensors 402, 404, and 406 distributed within the bioremediation area 102 (FIG. 1). The type of data collected by the sensors 402, 404, and 406 and provided to the analysis/control module 401 may depend on specific aspects of the system, but generally include physical and chemical parameters as described above. The analysis/control module 401 may also be operable to adjust the bioremediation by generating and sending adjustment commands to one or more of the bioremediation stations 104 (FIG. 1) and/or base stations 106 (FIG. 1).

Interfaced with the analysis/control module 401 may be monitoring systems 412, reporting systems 414, and/or adjustment systems 416. The monitoring systems 412 allow real-time and long-term oversight of the state of the bioremediation. Reporting systems 414 provide a time evolution of the bioremediation effort. Adjustment systems 416 provide for analysis of when adjustments to the bioremediation are required.

In operation, the analysis/control module 401 receives measurements of physical parameters associated with the bioremediation from the sensors 402, 404, and 406. Further, the analysis/control module 401 can also receive visual data 408, such as aerial or satellite photography, infrared imagery, microware imagery, RADAR, etc., for incorporation in the analysis of the bioremediation. Further, the analysis/control module 401 may receive other data 410 to use in analyzing the bioremediation. The data is provided to the monitoring system 412 to analyze the effectiveness of the bioremediation. The analysis from the monitoring system 412 or the data from the analysis/control module 401 may be provided to the reporting system 414 to provide to human analysts. If either automatic adjustments to the bioremediation are required, as determined by the monitoring system 412, or manual adjustments are made, the adjustment system formulates the adjustments and provides the adjustments to the analysis/control module 401. The analysis/control module 401 can then send commands to the one or more bioremediation stations 104 (FIG. 1) and/or base stations 106 (FIG. 1) to introduce an agent into the environment to adjust the bioremediation.

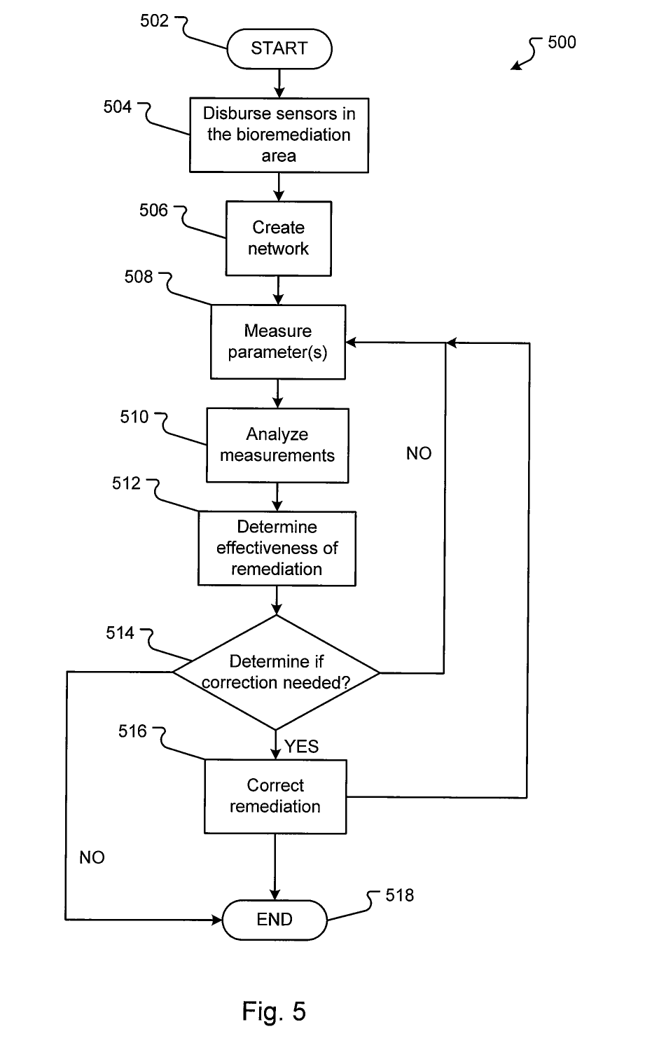

A method 500 for analyzing and/or adjusting a bioremediation is shown in FIG. 5. In embodiments, the method 500 generally begins with a START operation 502 and terminates with an END operation 518. The steps shown in the method 500 may be executed in a computer system as a set of computer executable instructions. While a logical order is shown in FIG. 5, the steps shown or described can, in some circumstances, be executed in a different order than presented herein.

Disburse operation 504 disburses one or more sensors into the bioremediation area. In embodiments, the sensors are part of one or more bioremediation stations 104 (FIG. 1) and/or base stations 106 (FIG. 1). The sensors may include systems to automatically adjust the bioremediation process as explained in conjunction with the base station 106 (FIG. 1). The disbursal may be as explained in conjunction with FIGS. 1 and 2.

Create operation 506 creates a network. In embodiments, the bioremediation stations 104 and/or base stations 106 form a peer-to-peer network as described in conjunction with FIGS. 1 and 2. Each bioremediation station 104 (FIG. 1) and/or base station 106 (FIG. 1) can connect with another bioremediation station 104 (FIG. 1) and/or base station 106 (FIG. 1). In embodiments, at least one bioremediation station 104 (FIG. 1) and/or base station 106 (FIG. 1) connects with a communication station 108 (FIG. 1) that can communicate with a central system 112 (FIG. 1).

Measure operation 508 measures one or more parameters. A parameter is a characteristic associated with the bioremediation, such as the presence of a chemical in the environment. One or more sensors or detectors 306, 308, and/or 310 (FIG. 3) included with one or more bioremediation stations 104 (FIG. 1) and/or base stations 106 (FIG. 1) make the measurements. The measurement may then be passed through the peer-to-peer network to the communication station 108 (FIG. 1) and on to the central system 112 (FIG. 1).

Analyze operation 510 analyzes the measurements. In embodiments, the central system 112 (FIG. 1) passes the one or more measurements to a monitoring system 412 (FIG. 4) that analyzes the measurements. The analysis performed may be time-based showing a progress of the bioremediation over a predetermined amount of time. Various forms of statistical analysis may be performed on the data, such as determining trends in the data. For example, measurements of a chemical having a decreasing amount over twelve different measurements can show a positive reduction trend in the chemical. The analysis can also determine the effectiveness in adjustments to the bioremediation. For example, three consecutive measurements, taken after the introduction of an agent, where the measurements are each three standard deviations below the mean level for a chemical can show a statistically significant effect on the environment. In embodiments, two or more photographs can be shown together or animated to show increase in vegetation, etc.

In further embodiments, the bioremediation may attempt to identify events that signify the effectiveness of the bioremediation. For example, the amount of a chemical reaching a certain parts per million. The predetermined event may be in terms of a single sensor measurement. Alternatively, the predetermined event may be in terms of a combination of multiple sensor measurements, such as the chemical having an average parts per million over an entire portion of the bioremediation area 102 (FIG. 1). In some instances, the event may be defined in terms of multiple parameters, such as where an event occurs when a chemical is at a parts per million level and oxygen is at a parts per million level that are cross predetermined thresholds.

Multiple derived parameters may be extracted from the data. The specific parameters that are extracted may depend on the number and types of configurations of sensors 104 (FIG. 1) distributed within the bioremediation system 100 (FIG. 1). In some embodiments, the parameters may be derived as mean and/or standard deviation of the collected data for a particular measurement parameter over a large time interval, and may comprise other statistical measures in other embodiments. In instances where the data comprise time-period correlatable data, the derived parameters may comprise autocorrelation parameters. The results of an autocorrelation calculation may be fitted to a curve having a generic shape that shows a decrease in the chemical or oil in the environment, with the fit coefficients acting as the derived parameters.

Such derived parameters may be determined in some embodiments for two different quantities X₁ and X₂. For instance, autocorrelation parameters may be derived from different types of data according to the specific configurations of the distributed sensors 104 (FIG. 1) by determining autocorrelation functions for chemical level and for oxygen level in one embodiment. In some embodiments, more than two derived parameters may be used, such as by additionally including an autocorrelation function for carbon dioxide data. In embodiments that use such multiple derived parameters, a cross-correlation of the derived parameters is calculated, and may be preceded by the application of fuzzy logic as part of the derived parameter extractions. The cross-correlation between derived parameters X₁ and X₂ may be calculated as

$${R}_{{X}_{1} {X}_{2}} = \frac{{\sum }_{i} ( {X}_{1}^{( i )} - {\overline{X}}_{1} ) {\sum }_{j} ( {X}_{2}^{( j )} - {\overline{X}}_{2} )}{{σ}_{{X}_{1}} {σ}_{{X}_{2}}} ,$$

where the mean of Xₖ (k=1, 2) is given over the set of N sensors as

$${\overline{X}}_{k} = \frac{1}{N} {\sum }_{i} {X}_{k}^{( i )}$$

and the standard deviation of Xₖ is given by

$${σ}_{{X}_{k}} = \sqrt{\frac{{\sum }_{i} {( {X}_{k}^{( i )} - {\overline{X}}_{k} )}^{2}}{N - 1}} .$$

In these calculations, the correlations are calculated over multiple sensors 104 (FIG. 1) identified by index i. The correlation determinations are generally performed over a greater number of sensors 104 (FIG. 1) distributed within the bioremediation area 102 (FIG. 1) than may be used to identify the occurrence of the event. Usually, the number of sensors 104 (FIG. 1) over which the correlations are determined is at least ten times the number of sensors 104 (FIG. 1) used in identifying the event, but may be smaller than ten times in some instances. In some embodiments, the correlation determinations are made from data collected at all sensors provided within the bioremediation area 102 (FIG. 1). In embodiments that use more than two derived parameters, the correlation may be determined in a manner analogous to the two-parameter cross-correlation function described above as

$${R}_{{X}_{1} {X}_{2} … {X}_{M}} = \frac{{\prod }_{m = 1}^{M} {\sum }_{i} ( {X}_{m}^{( i )} - {\overline{X}}_{m} )}{{\prod }_{m = 1}^{M} {σ}_{{X}_{m}}} .$$

Determine operation 512 determines if the bioremediation is effective. The results of the correlation determination are used to evaluate whether the bioremediation is effective. Such a determination may rely on whether the calculated correlation value is within a predefined range that specifies whether the bioremediation is correcting the contamination. If the bioremediation is deemed to be effective, the rate or level of effectiveness of the bioremediation may be evaluated, such as by determining the degree to which the calculated correlation value is outside the predefined normal range of the effectiveness curve.

In the above description, the calculations of correlation results have treated all sensors 104 (FIG. 1) equally. In other embodiments, different weighting factors wᵢ may be applied to each of the sensors 104 (FIG. 1) so that in the above calculations Xₘ⁽ⁱ⁾→wᵢXₘ⁽ⁱ⁾. The weighting factors wᵢ may reflect a determination that the information content provided by data from certain sensors 104 (FIG. 1) is more relevant in identifying effectiveness than the data from other sensors 104 (FIG. 1). For example, direct measurement of the contamination agent, e.g. the oil or the chemical, may be more heavily weighted than the measurement for a chemical associated with the contamination, e.g., oxygen level. The assignment of weighting factors may thus be an adaptive process in which the weighting factors are adjusted periodically on the basis of obtained versus desired results. Such backpropagation may be implemented using backpropagation neural networks or some similar design known to those of skill in the art.

Determine operation 514 determines if a correction to the bioremediation process is needed. In embodiments, if the bioremediation measurements are below an expected result, the adjustment system 416 (FIG. 4) may determine that an adjustment is required to promote the bioremediation. If a correction is needed, the method 500 flows YES to correct operation 516. If a correction is not needed, the method 500 flows NO back to measure operation 508. In embodiments, determine operation 514 may determine that no further correction will ever be needed, as when the bioremediation process is complete. If the bioremediation process is determined to be complete, the process flows NO to end operation 518.

Correct operation 516 corrects the bioremediation. In embodiments, one or more rules or computer algorithms for adjusting the bioremediation are predetermined. For example, if the level of a certain chemical is too high, the introduction of a different agent or chemical is required. The predetermined rules may be specific to the type of measurement, the location of the measurement (because different environments and vegetation may exist at each location), the abilities of the base station 106 (FIG. 1) to correct the bioremediation at the location, the success of a previous correction, etc. The adjustment system 416 (FIG. 4) forms a correct command and sends the command to the analysis/control module 401 (FIG. 4). The analysis/control module 401 (FIG. 4) determines to which base station 106 (FIG. 1) to address the correction command and sends the correction command to the determined base station 106 (FIG. 1) through the peer-to-peer network. The base station 106 (FIG. 1) executes the correction command, such as by spraying a chemical agent into the environment. After correcting the adjustment, the method 500 may flow back to measure operation 508 or may flow to end operation 518.

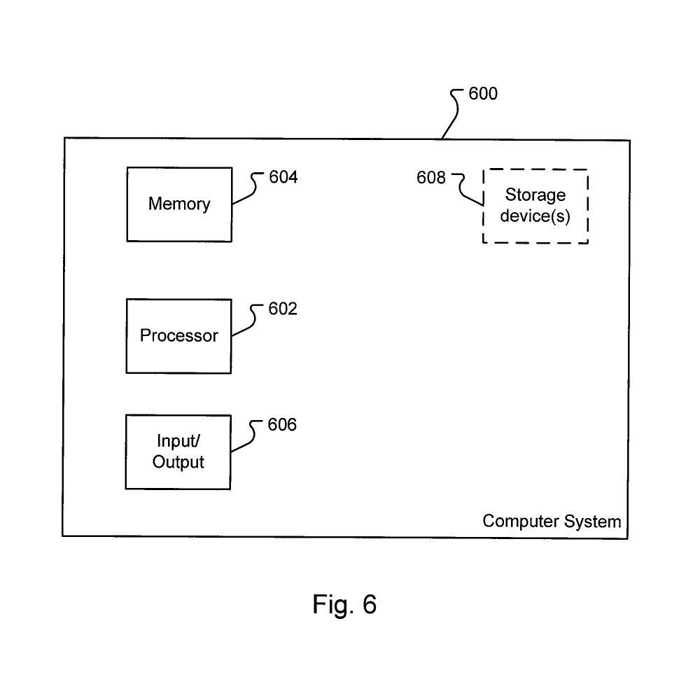

FIG. 6 provides a schematic illustration of a computer system 600 that may be used to implement the central system 112 (FIG. 1), the bioremediation stations 104 (FIG. 1), and/or the base stations 106 (FIG. 1). FIG. 6 broadly illustrates how individual system elements may be implemented in a separated or more integrated manner. The computer system 600 is shown comprised of hardware elements that may be electrically coupled via a bus, including a processor 602, input/output devices 606, storage device(s) 608, and memory 604. Memory 604 and/or storage device(s) 608 may include a computer-readable storage media reader connected to a computer-readable storage medium, the combination comprehensively representing remote, local, fixed, and/or removable storage devices plus storage media for temporarily and/or more permanently containing computer-readable information. The input/output devices 606 may comprise a wired, wireless, modem, and/or other type of interfacing connection and permits data to be exchanged with the intermediate active layer 110 (FIG. 1), databases 114 (FIG. 1), the peer-to-peer network, and other interfaces that may be used in coordinating processing for other environments.

The computer system 600 also comprises software elements, that may be located within working memory 604, including an operating system and other code, such as a program designed to implement methods of the disclosure. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

While various aspects of embodiments of the disclosure have been summarized above, the following detailed description illustrates exemplary embodiments in further detail to enable one of skill in the art to practice the disclosure. In the following description, for the purposes of explanation, numerous specific details are set forth in order to provide a thorough understanding of the present disclosure. It will be apparent, however, to one skilled in the art that the present disclosure may be practiced without some of these specific details. In other instances, well-known structures and devices are shown in block diagram form. Several embodiments of the disclosure are described below, and while various features are ascribed to different embodiments, it should be appreciated that the features described with respect to one embodiment may be incorporated with another embodiment as well. By the same token, however, no single feature or features of any described embodiment should be considered essential to the disclosure, as other embodiments of the disclosure may omit such features.

Specific details are given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. A computing system may be used to execute any of the tasks or operations described herein. In embodiments, a computing system includes memory and a processor and is operable to execute computer-executable instructions stored on a computer readable medium that define processes or operations described herein.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as a storage medium. A processor(s) may perform the necessary tasks. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

In light of the above description, a number of advantages of the present disclosure are readily apparent. For example, the bioremediation system 100 (FIG. 1) provides for automatic analysis of the effectiveness of a bioremediation. The bioremediation system 100 (FIG. 1) eliminates the need for scientists to manually measure the effectiveness of the bioremediation in the field. The bioremediation system 100 (FIG. 1) can cover large geographical areas and provide measurements associated with the bioremediation continually and over a long time period. Further, the bioremediation may automatically adjust the bioremediation based on measurements made by the bioremediation system. Still further, the bioremediation system 100 (FIG. 1) can integrate other types of data including satellite imagery, RADAR, or infrared photography.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

While the principles of the disclosure have been described above in connection with specific apparatuses and methods, it is to be clearly understood that this description is made only by way of example and not as limitation on the scope of the disclosure.

What is claimed is:

1. A system for monitoring the effectiveness of a bioremediation, the system comprising:
two or more bioremediation stations distributed spatially within a bioremediation area, each bioremediation station operable to measure a parameter associated with the bioremediation, each of the bioremediation stations being in peer-to-peer communication with another of the bioremediation stations to define a dynamically networked arrangement of bioremediation stations within the bioremediation area;
one or more communication stations in communication with at least one of the bioremediation stations to access the networked arrangement of the bioremediation stations and base stations; and
a central system in communication with the communication station and having programming instructions to analyze the effectiveness of the bioremediation from data collected by the two or more bioremediation stations.

2. The system as defined in claim 1, further comprising:
one or more base stations in communication with at least one of the bioremediation stations to access the networked arrangement of bioremediation stations, the base station operable to adjust the bioremediation;
wherein at least one communication station is in communication with at least one of the base stations; and
wherein the central system having programming instructions to adjust the bioremediation by sending commands to one or more of the base stations.

3. The system as defined in claim 1, wherein the programming instructions include:
instructions to identify the occurrence of an event by identifying a change in an event-defining parameter;
instructions to extract a plurality of derived parameters from the collected data;
instructions to determine a cross-correlation of the extracted plurality of derived parameters over the plurality of bioremediation stations; and
instructions to identify the effectiveness from the determined cross-correlation.

4. The system as defined in claim 3, wherein:
the collected data comprise a plurality of time-period correlatable parameters; and
the instructions to extract the plurality of derived parameters comprise instructions to calculate an autocorrelation of each of the plurality of time-period correlatable parameters.

5. The system as defined in claim 1, wherein the bioremediation system comprises a hierarchical branching network with the plurality of bioremediation stations distributed throughout the hierarchical branching network.

6. The system as defined in claim 1, wherein each bioremediation station has one or more detectors.

7. The system as defined in claim 6, wherein at least one detector detects a chemical.

8. The system as defined in claim 6, wherein at least one detector detects temperature.

9. The system as defined in claim 6, wherein at least one detector is selected from the group consisting of a temperature detector, a pH detector, a thermal conductivity detector, and an electrical conductivity detector.

10. The system as defined in claim 1, wherein the bioremediation system receives imagery data.

11. The system as defined in claim 1, wherein the bioremediation system receives infrared data.

12. The system as defined in claim 1, wherein the bioremediation system adjusts the bioremediation automatically by introducing an agent into the bioremediation area.

13. The system as defined in claim 1, wherein at least one of the bioremediation stations is connected to a base station and receives power from the base station.

14. The system as defined in claim 1, wherein:
the bioremediation area includes two or more environments; and
the central system further has programming instructions to correlate bioremediation effectiveness identified in each of the environments to provide adjustments to the bioremediation that is specific to each of the two or more environments.

15. A method for monitoring a bioremediation, the method comprising:
collecting data from a plurality of bioremediation stations distributed spatially within a bioremediation area, each of the bioremediation stations being in peer-to-peer communication with another of the bioremediation stations to define a dynamically networked arrangement of bioremediation stations within the bioremediation area, at least one of the bioremediation stations having a detector; and
determining the effectiveness of the bioremediation in one or more portions of the bioremediation area from the collected data.

16. The method as defined in claim 15 wherein determining the effectiveness from the collected data comprises:
identifying a change in a parameter;
extracting a plurality of derived parameters from the collected data;
determining a cross-correlation of the extracted plurality of derived parameters over the plurality of bioremediation stations; and
identifying the effectiveness from the determined cross-correlation.

17. The method as defined in claim 16 wherein:
the collected data comprise a plurality of time-period correlatable parameters; and
extracting the plurality of derived parameters comprises calculating an autocorrelation of each of the plurality of time-period correlatable parameters.

18. The method as defined in claim 15 wherein the bioremediation system comprises a hierarchical branching network with the plurality of bioremediation stations distributed throughout the hierarchical branching network.

19. The method as defined in claim 15 wherein the collected data includes a parameter that determines the presence of a chemical.

20. The method as defined in claim 15 wherein the at least one of the bioremediation stations further has a detector selected from the group consisting of a chemical detector, a temperature detector, a pH detector, a thermal conductivity detector, and an electrical conductivity detector.

21. The method as defined in claim 15, further comprising creating a network with the two or more bioremediation stations.

22. The method as defined in claim 15 wherein the bioremediation area includes a plurality of environments, the method further comprising:
monitoring a state of each environment; and
correlating abnormalities identified in each of the environments to provide a collective characterization of the plurality of environments.

23. A bioremediation station for monitoring or adjusting a bioremediation, the bioremediation station comprising:
one or more detectors operable to monitor one or more parameters associated with a bioremediation;
a remediation system operable to introduce one or more agents into the environment to adjust the bioremediation;
a communications interface operable to communicate with one or more other bioremediation stations to create a peer-to-peer network; and
a microcontroller in communication with the one or more detectors, the remediation system, and the communications interface, the microcontroller operable to send parameter measurements from the one or more detectors, send the parameter measurements to a central system via the communications interface, receive an adjustment command via the communications interface, and to execute the command with the remediation system.
